(19) United States
(12) Patent Application Publication
(10) Pub. No.: US 2006/0155393 A1
(43) Pub. Date: Jul. 13, 2006

(54) Method and system for converting ladder logic to boolean logic in a process control system

(75) Inventor: Frederick F. Klein, Monroeville, PA (US)

Correspondence Address: MARSHALL, GERSTEIN & BORUN LLP, 233 S. WACKER DRIVE, SUITE 6300, SEARS TOWER, CHICAGO, IL, 60606, US

(73) Assignee: EMERSON PROCESS MANAGEMENT POWER & WATER SOLUTIONS, INC., Pittsburgh, PA (US)

(21) Appl. No.: 11/032,273

(22) Filed: Jan. 10, 2005

(51) Int. Cl. G05B 11/01; G05B 19/42

(52) U.S. Cl. 700/18; 700/86; 700/87

(57) ABSTRACT

Disclosed herein is a method of converting a ladder logic routine into Boolean logic. Boolean representations of the ladder logic elements of the ladder logic routine are collected in respective logic expressions for each ladder rung of the plurality of ladder rungs defining the ladder logic routine. Boolean logic elements are then resolved from the logic expressions. The Boolean logic elements are then stored in a memory in an order in which the Boolean logic elements are resolved to express the ladder logic routine in accordance with an execution order of the ladder logic routine.

### BACKGROUND OF THE INVENTION

1. Field of the Invention

The invention generally relates to process control routines and, more specifically, to control routines using ladder logic.

2. Brief Description of Related Technology

Ladder logic has often been used to express control routines implemented in process control systems. Ladder logic has its origins in expressing relay-based logic, where each relay is expressed as a coil and one or more contacts controlling whether the coil is energized. To that end, the contacts and coil for each relay are arranged on a rung connected between two power rails, thereby presenting a ladder. Outside of relays and relay networks, ladder logic has been extensively applied as a standard programming paradigm for programmable logic controllers (PLCs), which have been used to implement control logic for a variety of process control operations. The logic and routines executed by PLCs may often be expressed in other programming paradigms, such as Boolean logic. However, ladder logic has remained one of the preferred programming paradigms, particularly when the logic can be easily expressed as a series of relay coils and contacts.

To address the increased complexity of process control routines, process control systems utilizing PLCs have been upgraded to incorporate more advanced digital controllers that execute control logic expressed via higher level programming structures or languages, such as object-oriented programming languages. These advanced controllers are routinely integrated in widespread networks that rely on distributed process control techniques having one or more operator workstations to provide user interfaces for configuration, maintenance, and other control functions. In these cases, the user interfaces provide the capability of reprogramming a controller remotely. To this end, the workstations and other user interfaces execute configuration software and other routines that enable control personnel to view and modify the control logic being implemented throughout the process control system. As a result of these innovations, maintaining a process control system that integrates a number of controllers can be handled without requiring personnel to visit each controller individually with a handheld or other portable device for programming and other work, as was often the case with PLCs.

Despite these advances and innovations in process control, many systems are still using ladder logic to express the control logic executed by controllers or other devices within the network. Unfortunately, personnel responsible for maintaining the system may now be more comfortable working with the higher level programming languages and Boolean logic, rather than ladder logic. As a result, maintenance and other work directed to improving or re-configuring ladder logic systems may inefficiently require one or more manual translations of the logic. More specifically, a first translation process may be required to convert the control routine from ladder logic into Boolean logic to enable those individuals more familiar with Boolean logic to diagnose problems or design improvements in the control routine. Because this translation is often performed manually, the process is often time-consuming and prone to errors, in which case further translations may become necessary.

U.S. Pat. No. 5,623,401 issued to Baxter describes a control system operating method that involves a technique for converting ladder logic of a limited and simplistic nature (e.g., only coils and contacts) into flow type programs of Boolean gates for the purpose of improving the response time of a control system. The end result is a sequence of transition routines that ensures that only changes in certain variables are processed during operation. Thus, these transition routines are generated to optimize execution, rather than for supporting the types of logic design, configuration, maintenance or other work described above in the context of advanced process control systems. As a result, the results are not made available, stored or expressed in a way that supports further design, configuration, maintenance or other work on the logic routine.

### SUMMARY OF THE INVENTION

Disclosed herein is an automated logic conversion technique that may be implemented as a system, method or computer program for automated translation or conversion of a routine expressed in ladder logic. The disclosed technique converts the ladder logic into a set of Boolean logic elements in a manner that enables further design, configuration, maintenance, and other work on the routine and the underlying logic.

In accordance with one aspect of the conversion technique, a method is useful for processing a routine expressed via ladder logic elements arranged in a plurality of ladder rungs and in accordance with an execution order. The method includes collecting Boolean representations of the ladder logic elements in a respective logic expression for each ladder rung of the plurality of ladder rungs, resolving Boolean logic elements from the logic expressions, and storing information regarding the Boolean logic elements in a memory in accordance with the execution order to express the routine in Boolean logic.

In certain embodiments, the resolving step is performed if further collection of the Boolean representations in one of the respective logic expressions would result in a combination of dissimilar Boolean logic functions.

The collecting step may include the steps of evaluating each ladder logic element to determine an operation effected thereby and updating the respective logic expression to reflect the operation. The storing step may include the step of writing to the memory a definition of the Boolean logic element as an object disassociated from the logic expression. The object may be written to a position in the memory relative to further objects associated with further Boolean logic elements that preserves the execution order of the routine. The ladder logic elements may be arranged in columnar positions within each ladder rung and wherein the execution order proceeds in columnar fashion.

In one embodiment, the method further includes the step of proceeding to a different ladder rung of the plurality of ladder rungs for a subsequent ladder logic element evaluation prior to evaluating another ladder logic element in the first-named ladder rung.

In cases where the ladder logic has special functions, the method includes the steps of (i) identifying a non-Boolean function having units spread over multiple ladder rungs of the plurality of ladder rungs, and (ii) resolving a further Boolean logic element from a respective logic expression for the ladder rung of the plurality of ladder rungs connected to an input of the non-Boolean function. The method may further include the step of storing an object representative of the non-Boolean function in the memory in accordance with the execution order.

In one embodiment, the collecting step includes the step of combining two or more respective logic expressions for adjacent ladder rungs of the plurality of ladder rungs linked via one or more OR functions to create a composite logic expression for each of the two or more respective logic expressions. The combining step may include the step of executing a recursive procedure.

In accordance with another aspect of the conversion technique, a system includes a processor, a computer-readable memory coupled to the processor, and a logic conversion routine stored in the computer-readable memory and configured to be executable by the processor. The logic conversion routine, in turn, includes a ladder logic element processing routine that collects Boolean representations of the ladder logic elements in a respective logic expression for each ladder rung of the plurality of ladder rungs. The ladder logic element processing routine then resolves a Boolean logic element from the respective logic expression when further collection would set forth dissimilar Boolean functions in the respective logic expression.

In one embodiment, the logic conversion routine further includes an OR function processing routine that, when an OR function is encountered, (i) combines multiple, respective logic expressions for adjacent ladder rungs of the plurality of ladder rungs connected by the OR function to reflect a combination of the multiple, respective logic expressions and, (ii) modifies each of the multiple, respective logic expressions to reflect the combination. The OR function processing routine may execute a recursive procedure.

The ladder logic element processing routine may include a coil processing routine that, when a coil is encountered in a current ladder rung of the plurality of ladder rungs, resolves the logic expression for the current ladder rung into a further Boolean logic element.

In accordance with yet another aspect of the conversion technique, a computer program product is stored on a computer-readable medium for conversion of a ladder logic routine. The computer program product includes first, second and third instructions sets. The first instruction set collects Boolean representations of the ladder logic elements in a respective logic expression for each ladder rung of the plurality of ladder rungs. The second instruction set then determines whether to resolve Boolean logic elements from the logic expressions. The third instruction set then stores the Boolean logic elements in a memory in accordance with an order in which the Boolean logic elements are resolved.

In one embodiment, the second instruction set may be executed when further collection of the Boolean representations in one of the logic expressions by the first instruction set would result in a combination of dissimilar Boolean logic functions.

The first instruction set may evaluate each ladder logic element to determine an operation effected thereby and update the respective logic expression to reflect the operation.

The third instruction set may write to the memory respective definitions of each Boolean logic element as a respective object disassociated from the logic expression from which the Boolean logic element was resolved. In one embodiment, the order in which the objects are stored preserves an execution order of the ladder logic routine.

### BRIEF DESCRIPTION OF THE DRAWING FIGURES

For a more complete understanding of the invention, reference should be made to the following detailed description and accompanying drawing wherein:

FIG. 1 is a schematic representation of an exemplary process control system that executes a ladder logic routine suitable for conversion by the disclosed technique, together with one or more systems or devices capable of implementing a logic conversion routine in accordance with one embodiment;

FIG. 2 is a schematic representation of an exemplary ladder logic routine having ladder logic elements, including a special function element;

FIG. 3 is a flow diagram depicting a ladder logic conversion routine for processing the exemplary ladder logic routine of FIG. 2 in accordance with one embodiment of the disclosed conversion technique;

FIG. 4 is a flow diagram depicting a coil compression portion of the conversion routine of FIG. 3 in greater detail;

FIG. 5 is a flow diagram depicting collection and processing portions of the conversion routine of FIG. 3 in greater detail;

FIG. 6 is a flow diagram depicting a coil and contact evaluation and processing portion of the conversion routine of FIGS. 3 and 5 in accordance with one embodiment;

FIG. 7 is a flow diagram depicting a special function evaluation and processing portion of the conversion routine of FIGS. 3 and 5 in accordance with one embodiment; and,

FIGS. 8A-8C are flow diagrams depicting an OR function evaluation and processing portion of the conversion routine of FIGS. 3 and 5 in accordance with one embodiment.

While the disclosed conversion technique is susceptible of embodiments in various forms, there are illustrated in the drawing (and will hereafter be described) specific embodiments of the invention, with the understanding that the disclosure is intended to be illustrative, and is not intended to limit the invention to the specific embodiments described and illustrated herein.

### DETAILED DESCRIPTION OF THE EMBODIMENTS

The disclosed embodiments generally relate to automated conversion or translation of ladder logic to Boolean logic and, thus, may be useful in connection with a process control system having devices that execute routines expressed in ladder logic. More particularly, configuration, design, maintenance, programming, or other work toward maintaining or improving the operation of such process control systems may benefit from such conversion or translation if, for instance, operators or other personnel are unfamiliar with ladder logic. However, even though the disclosed embodiments are particularly well suited for converting process control routines, practice of the disclosed embodiments is not limited to application within any particular type of system or context, or execution on any particular workstation or other hardware arrangement. Rather, the automated conversion technique disclosed herein may be applied to any one of a number of different computing platforms without regard to the context or application in which the underlying ladder logic is executed. Thus, any direct or implied reference herein to a particular type of routine (e.g., a process control routine), context, application, or system in which the disclosed embodiments are incorporated or practiced is made only for the convenience of illustrating the disclosed technique.

Practice of the disclosed embodiments is also not limited to any one particular ladder logic paradigm or convention. In fact, the disclosed conversion technique is compatible with a wide variety of ladder logic rules. For instance, the disclosed conversion or translation technique may be applied to a routine including non-standard ladder logic elements (i.e., other than contacts and coils), such as timers, flip-flops, and other special functions. Such functions are generally addressed as one of a catalog of special functions addressed by one embodiment of the disclosed technique. The underlying ladder logic may also have a vertical, horizontal, or other execution order, as will be explained further herein, such that the logic underlying such execution ordering will be preserved in the translation or other output of the conversion routine.

More generally, and in accordance with one embodiment, the disclosed conversion technique is based in part on the collection of Boolean representations of ladder logic elements in separate logic expression dedicated to each rung of the ladder in which the ladder logic elements are arranged. Each respective logic expression is updated or modified as the automated conversion technique sequentially processes or evaluates each ladder logic element in the ladder. The logic expressions generated by the conversion routine do not, however, constitute the output of the disclosed system, method or computer program. The logic expressions are, in fact, intermediate results (i.e., working or temporary parameters) utilized during the conversion processing, even though the Boolean representations in the logic expressions may, in some embodiments, set forth formal Boolean logic having a complete or cohesive set of elements, operators, operations, or functions. Instead, distinct Boolean logic elements are resolved from the logic set forth in the expressions as the processing of the ladder progresses. An element is resolved during certain processing to avoid the collection of dissimilar Boolean function in a logic expression, although elements may be resolved under several different circumstances. These Boolean logic elements are then stored in the order in which they are generated and in a manner that (i) supports subsequent maintenance and other work on the routine being converted, and (ii) maintains the execution order of the underlying ladder logic.

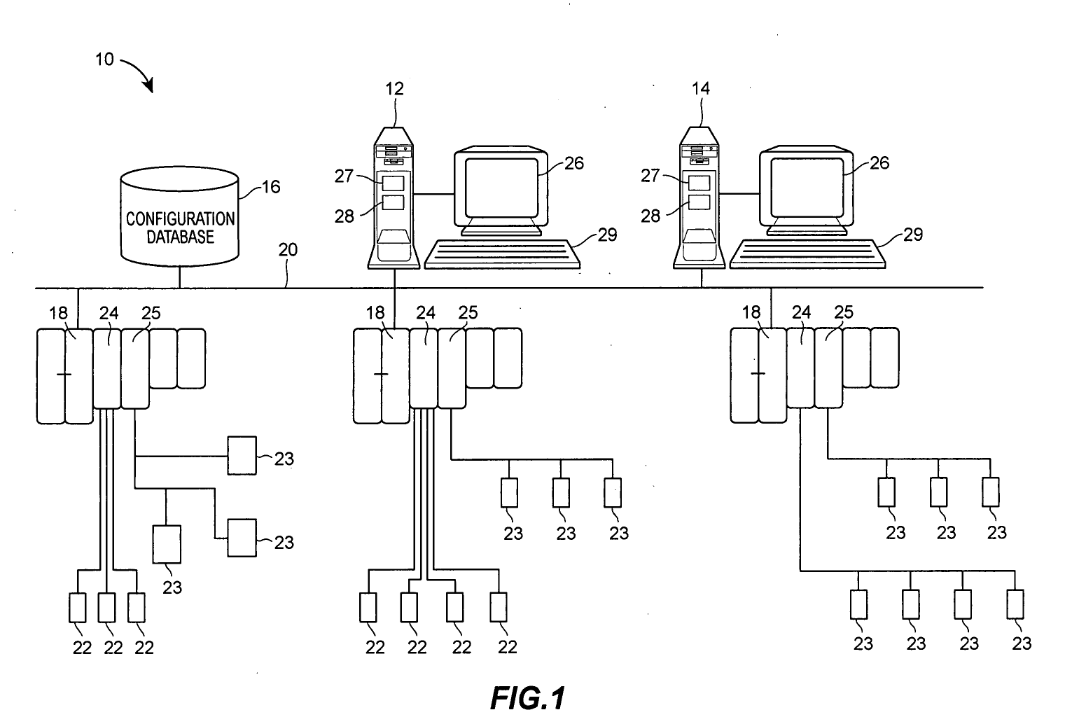

FIG. 1 illustrates an exemplary process control system indicated generally at 10 to set forth one context in which the underlying ladder logic, or the resultant Boolean logic, may be executed. Stated differently, the disclosed conversion routine may therefore receive input data from, and provide output data to, one or more components of the system 10. In this case, the conversion routine is implemented by a workstation, personal computer or other device unassociated with, disconnected (e.g., off-line) from, and/or remotely located from the system 10. Indeed, the disclosed conversion technique may be implemented using any hardware or software platform. In an alternative embodiment, however, one or more components of the system 10 may be capable of supporting the execution of the conversion routine. The following description may refer to implementation of the conversion routine in this manner (i.e., where components of the system 10 execute the conversion routine), but only in the interest of ease in illustration.

The process control system 10 includes user interfaces 12 and 14, which may be, for example, workstations or computers connected in a communication network to a number of other devices such as a data storage device or historian 16 and any number of controllers 18 via a system level data bus 20. The system level data bus 20 may be an Ethernet data bus or any other data bus suitable for the transmission of data. The controllers 18 may be, for example, a DCS (distributed control system) controller and may communicate with the user interfaces 12 and 14 using a proprietary communication protocol, or in any other suitable manner, via the system level data bus 20, to execute the underlying ladder or resultant Boolean logic. The underlying ladder or resultant Boolean logic may be implemented in the controller 18 as control algorithms or routines for use in controlling field devices that are connected to the controller 18 in any conventional or any other desired manner.

As shown in FIG. 1, each controller 18 is in communication with any number of field devices 22, 23 via one or more linking devices 24, 25, which may be, foe example, an input/output (I/O) card for the Hart protocol. The field devices 22, 23 communicate with one another and the linking device 24, 25 to execute one or more process control loops either in conjunction with or independently from the controller 18. In this way, the controller 18 may act as a MAC (multi-application controller) or a DPU (distributed processing unit), but in either case supports the execution of control logic for data acquisition and control strategies (e.g., PID control) for the field devices 22, 23. The field devices 22, 23 may be, for example, Hart compatible devices. Other device/wire topologies may also be used, including point to point connections, and tree or “spur” connections.

Either one of the user interfaces 12, 14, or both, may be an engineering station such as the Ovation workstation available from Emerson Process Management, Power & Water Systems (Pittsburgh, Pa.) or any other similar workstation running on a UNIX platform. Alternatively, or in addition, one of user interfaces 12, 14, or both, may be a personal computer running on any one of a number of other operating systems, such as Microsoft Windows. Either one of the user interfaces 12 or 14, or both, may be relied upon to implement, or support the implementation of, the disclosed logic conversion technique. As set forth above, however, implementation of the conversion routine does not require either user interface 12, 14 (or any other process control system workstation or device), and may instead rely on a standard personal computer outside of the network associated with the system 10. Thus, in one embodiment, one of the user interfaces 12, 14 may not be coupled to the bus 20 as shown in FIG. 1 to signify that the disclosed logic conversion technique may be practiced off-line. More generally, the personal computer, workstation or other computer implementing the routine may, but need not, be connected or communicatively coupled to the network shown in FIG. 1 in any manner. In cases where the conversion is implemented in a manner disassociated or disconnected from the system 10, the resultant Boolean logic, i.e., output data, of the conversion routine may be uploaded or transferred in any manner to the user interfaces 12, 14 or other components of the system 10 for use in process design, configuration, calibration, and other work.

In certain cases, the disclosed conversion technique may be implemented or practiced within a process control system as part of a package of software utilities or tools. Regardless of the degree to which it is integrated with other tools or software, the conversion routine may be configured to execute on any one of a number of different hardware and software platforms, and is not limited to any proprietary operating system, hardware, programming language, or software configuration. While the disclosed logic conversion technique may be implemented in software as a computer program executed by one or more general-purpose processors, the disclosed technique may also be implemented using dedicated hardware, firmware, software, or any combination thereof. In either case, the disclosed logic conversion technique may be implemented as part of a broader suite of utilities or functions available for controlling the process and the process control system 10 more generally. These utilities and functions may include, for instance, configuration and edit functions that allow an operator to create the ladder logic routines to be converted by the disclosed technique.

With continued reference to the exemplary embodiment of FIG. 1, each user interface 12 and 14 has a display and/or other output device 26 that facilitates the management and maintenance of the control strategy throughout the system 10 through menus, windows, and other standard information display techniques. To that end, configuration and other software (such as, in some embodiments, the disclosed conversion routine) may be resident in a memory 27 of each user interface 12, 14 for execution by a respective processor 28. Each user interface 12 and 14 also includes one or more input devices 29, such as a keyboard or selection device, to facilitate the entry of configuration, control, and other information and data.

The processor 28 may be any type of processor but, preferably, is a general purpose, programmable processor such as those generally used in personal computers, UNIX workstations, and the like. The memory 27 may be any desired type of memory.

The controller 18 also includes a processor that implements or oversees one or more process control routines (stored in a memory), which may include control loops, stored therein or otherwise associated therewith and communicates with the devices 22, 23, the user interfaces 12 and 14, and the data historian 16, to control a process in accordance with, for instance, the underlying ladder logic routine to be converted. It should be noted that the underlying routine may have parts thereof implemented or executed by different controllers or other devices if so desired. Likewise, the underlying routine may take any form, including software, firmware, hardware, etc. For the purpose of this disclosure, control routines, which may be modules or any part of a control procedure such as a subroutine, parts of a subroutine (such as lines of code), etc., may be designed using any design tools, including graphical design tools or any other type of software/hardware/firmware programming or design tools.

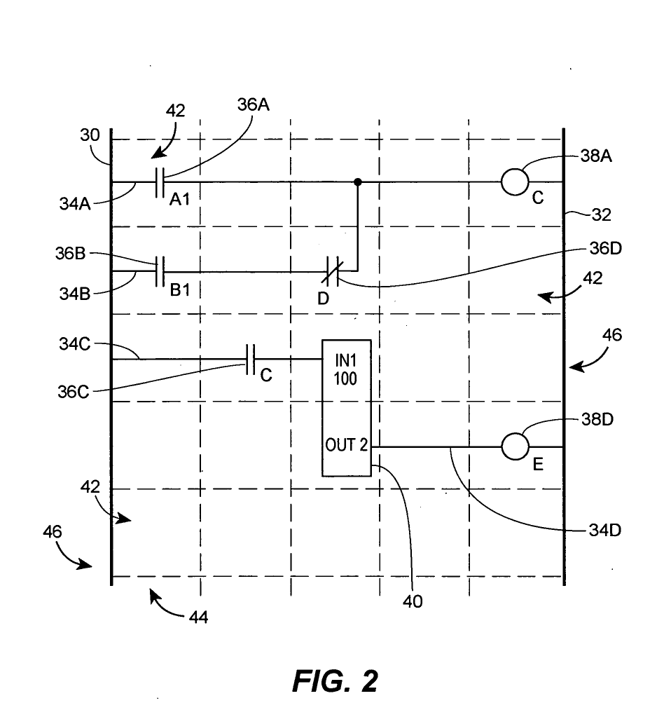

In an embodiment where the underlying routine is executed by the controller 18, the user interfaces 12, 14 may provide on- and off-line, graphical monitoring and other control functionality in connection therewith. The underlying routine may therefore be expressed in graphical ladder logic, as shown in FIG. 2, via one or more of the displays 26. In alternative embodiments, the underlying routine may be stored in different locations in the process control system 10 and, thus, may reside in one or both of the memories 27 of the user interfaces 12, 14, or the data historian 16, regardless of whether the routine may be executed at the controller level. More generally, practice of the disclosed conversion technique is not dependent upon where the control routine resides or is executed. Accordingly, the control routine may, in some embodiments, be implemented or stored in a distributed fashion and/or made available for execution, implementation, or conversion, in a remote manner.

FIG. 2 depicts a routine expressed in ladder logic and of a simplified nature solely for the purpose of illustrating the disclosed conversion technique in accordance with one or more embodiments. The routine shown in FIG. 2 may be implemented in any context, but would likely be much more complex, with many more logic elements, if implemented within the process control context noted above in connection with FIG. 1. Nonetheless, application of the disclosed conversion technique is well suited for a control routine of any size or complexity, inasmuch as the technique involves processing the ladder logic in a systematic, sequential fashion in accordance with the execution order of the ladder logic. As a result, the systematic approach of the disclosed conversion technique involves progressing through the ladder logic, such as the logic shown in the routine of FIG. 2, in the order or sequence determined by the execution order, and generating the Boolean logic output as it progresses through the sequence (i.e., on the fly). Storing the Boolean logic output in the order in which it is generated also allows the output to reflect and maintain the execution order of the underlying ladder logic.

Ladder logic generally, as well as the logic elements of the control routine shown in FIG. 2, are well known to those skilled in the art, and will only be briefly introduced. In accordance with standard ladder logic convention, the routine is set forth via a number of logic elements between two power rails 30 and 32. As an initial matter, a logic element, as used herein, refers to any portion or aspect of a logic routine (ladder or Boolean) such that a logic element may be expressed graphically or textually, and in varying levels of specificity or detail. For example, a logic element may be an operator (e.g., AND, OR, normally open contact, and the like), an operand (e.g., A1, B2, TRUE, FALSE, and the like), a logic function involving one or more operators or operands (e.g., “A1 OR B2”, TRUE, etc.), or the identification, symbol, or variable (e.g., C) set equal to the function (e.g., as in C=A1 OR B2). Logic elements may also constitute, include, involve or relate to special functions and specific aspects thereof (e.g., a timer, its duration, etc.), to the extent such special functions are integrated into a ladder or Boolean logic routine. A logic expression, as used herein, refers to any expression of one or more logic elements that sets forth a function, operation or other portion of a logic routine, either graphically, textually or in any other manner of form, regardless of the manner or level of detail in which it is expressed (e.g., whether expressed via a reference symbol, identification, or variable, the underlying logic function or operation, etc.). In one embodiment, as set forth below in more detail, a logic expression may be a character string having the logic elements set forth textually. More generally, however, the combination of logic elements describes or defines the logic routine. This description or definition may form the input data provided to the logic conversion routine, and it may also be used during execution of the ladder.

The exemplary routine of FIG. 2 is defined by a number of rungs 34A-34D that generally extend from one power rail 30 to the other power rail 32, although one or more rungs 34B may be connected to another rung 34A, as shown. Each rung 34A-34D may support one or more logic elements along the way, and may be considered a logic element itself, in the sense that a direct connection via a ladder rung (or line) maintains the logic state or value of the signal carried thereby. For instance, the rungs 34A-34C are directly connected to the power rail 30 such that the logic state or value of the rail 30, namely TRUE (or equivalently “ON” or “1”), is maintained until a normally open contact 36A-36C is respectively encountered along the way to the other rail 32. Contacts may also be normally closed, as is the case with contact 36D along the rung 34B. More generally, contacts and other logic elements help to define the state of each rung during operation (i.e., execution of the logic routine). The state of each rung, in turn, may determine the value or state associated with a further logic element, such as a coil. For instance, the rungs 34A and 34D also include coils 38A and 38D, respectively. In the case of the coil 38A, the logic routine may use the value or state of the coil 38A as another logic variable to be used elsewhere in the routine, such as the operand for the contact 36C. In contrast, the value of the coil 38D may reflect or determine an output control signal that determines, for instance, whether a valve actuator is energized. Working backwards to see how the logic routine of FIG. 2 might cause the actuator to be controlled, the hypothetical valve actuator is energized (or activated) for a time period established by a timer 40 that sends a value of TRUE or “1” to the coil 38D only after the power rail 30 is connected to the timer 40 via the contact 36C. The contact 36C, in turn, is closed to activate the timer 40 only when the logic elements on the rungs 34A and 34B allow the coil 38A to be energized (e.g., have a value of TRUE or

In accordance with one embodiment of the disclosed conversion technique, the ladder logic of the control routine to be converted is organized or parsed into a number of cells or units indicated generally at 42. For example, in the routine of FIG. 2, the rung 34A has five cells or units 42, the leftmost of which contains the contact 36A. More generally, each cell 42 may contain any logic element (e.g., a line, contact, or coil) or nothing at all, as shown in a number of cells in the routine of FIG. 2. In certain embodiments, each cell 42 may be defined in accordance with one or more attributes or parameters. A “SHAPE” attribute may, for instance, be used to establish the presence of a contact, coil, line (i.e., pass through), or special function, or the absence of such elements. A “ROW” attribute may identify the row number of the cell, while a “COLUMN” attribute may identify the column number. If the cell 42 contains a contact, then an “NC” attribute may establish whether the contact is normally closed (a value of “TRUE”) or normally open (a value of “FALSE”). Contact cells may also use an “IN” attribute to identify the variable evaluated to determine the state of the contact. For purposes of ease in illustration, this variable or identification symbol is referred to herein as a “point name” and may often include the identification of a bit number if several distinct values are packed into, or arrayed in, a single point. In this way, the point name identifies a specific location within a memory of the system 10 in which the value associated with the point name can be found. More generally, as used herein, the term “point name” may refer to the name, identifier, or other identification information, for a variable evaluated or created during the execution of the logic routine being converted, or during execution of the disclosed logic conversion routine. If the cell 42 contains a coil, then an “OUTPUT” attribute may identify the point name (and the bit number in certain cases) of the variable whose value or state is established by the rung in which the coil in question is disposed. An “OR” attribute may be used to identify when the cell 42 involves a connection to another rung, such that a value of “TRUE” signifies the presence of an “OR” function. Other attributes may be used to facilitate the definition of special functions, and an exemplary approach to such cases will be described herein below in connection with one embodiment.

As is well known to those skilled in the art, the ladder logic may be stored in a textual, graphical or other manner, but in any case, the attribute data for each cell is associated therewith to completely define the logic.

Parsing the routine into the units or cells 42 organizes the routine into a number of columns indicated generally at 44 and rows indicated generally at 46. Apart from defining the location of each cell 42 by column and row number, such organization is typically used by those skilled in the art to establish an ordered sequence for the logic. In other words, the parsing of the ladder into the cells 42 is a straightforward way of establishing or defining the execution order of the routine. Without knowing the execution order, the execution of the routine may not be consistent, particularly when logic elements such as the coil 38A are used to determine the state of other logic elements within the routine, such as the contact 36C. In such cases, proceeding through the ladder in a different order would, in execution, change the way the underlying routine executes and, in conversion to Boolean logic, result in an erroneous translation.

In the event that a ladder has yet to be organized into cells, a parsing routine known to those skilled in the art can be used to organize the ladder routine into columns, rows, and/or cells, provided that the execution order or other convention for the ladder is known or can be easily surmised. Parsing the underlying logic need not result in a set of rectilinear units or cells defined by columns and rows, however. For instance, the underlying routine may have a sequence of units or other portions that are defined in accordance with the execution order. In fact, as long as the execution order (or, equivalently, the operation) of the ladder is known, established, or otherwise defined, the conversion routine will be able to sequentially process the portions of the ladder appropriately to generate an accurate translation.

Thus, despite the advantages of parsing the routine into cells or units, practice of the disclosed technique is not limited to ladder logic systems that have defined cells or units. Rather, the disclosed technique may be applied to any ladder logic having an ordered or defined sequence of logic elements. In that way, the disclosed technique progresses through the ladder in the proper sequence of logic elements, thereby preserving the execution order of the logic in the process.

As explained above in connection with the routine of FIG. 2, the execution order, or order in which the logic elements should be scanned or evaluated, may be critical to execution of the routine. Unfortunately, different systems have employed different ladder scanning conventions, rendering automated translation more complicated. The disclosed conversion technique, however, is not limited to any one scanning convention.

One scanning convention establishes a horizontal execution order, such that the logic elements in a row are all evaluated, generally moving from left to right, prior to moving on to the next row, typically the one immediately below the current row. Of course, such horizontal scanning may begin with any cell of the ladder, and then proceed either right-to-left, or from bottom rows toward the top of the ladder. Alternatively, the ladder may have a scanning convention that establishes a vertical or columnar execution order, in which the logic elements in a column are evaluated prior to moving to an adjacent column. Typically, evaluation would proceed from left to right, top to bottom, but other starting points and evaluation directions may be selected. For the purposes of ease in illustration, the following description of the disclosed conversion technique will assume a vertical execution order, beginning with the upper, left-most cell.

One other ladder logic convention is directed to the connection of two or more ladder rungs at certain instances between the rails 30 and 32. Such connections create an OR function with two or more operands. In one embodiment of the disclosed conversion technique, the parsing of the ladder into cells or units also identifies which cells are identified as having the connection, or the “OR” function. For the sole purpose of ease in illustration, and in one exemplary embodiment, the aforementioned “OR” attribute will be assigned a value of “TRUE” only for the bottom of the two cells making the connection. In the exemplary embodiment shown in FIG. 2, the cell 42 containing the contact 36D would therefore have an “OR” attribute set equal to “TRUE,” while the cell 42 immediately above it would have an “OR” attribute set equal to “FALSE” even though the ladder graphically shows that the connection is made there. It should be noted, however, that this rule is only a matter of convention concerning the connection of two or more rungs, such that practice of the disclosed conversion technique is not limited to the manner in which the attributes are set. While this convention may help subsequent processing or execution of the logic proceed as efficiently as possible (e.g., by knowing when to initiate certain steps for processing an “OR” function), in alternative embodiments, the contact 36D and the “OR” function may, for example, be disposed in adjacent (i.e., separate) cells along the rung 36B, or the “OR” function may be associated with the cell 42 above the cell containing the contact 36D.

In the process control context, these conventions or rules are established by the process control application or system (e.g., configuration software) utilized to design and/or execute the ladder logic. For each given process control system or application, conversion of the underlying ladder logic of the control routine may then proceed in a sequence in accordance with its ladder logic conventions. Generally speaking, this sequence, or the order in which the underlying ladder logic is evaluated by the disclosed logic conversion routine, is the same as the execution order, i.e., the order in which the underlying logic is evaluated during execution. Thus, the logic conversion routine translates the underlying logic in systematic fashion in accordance with the execution order, generating the Boolean logic output on the fly and storing the output in a manner that maintain the execution order. Generation “on the fly” refers to how the output of the conversion routine is generated gate-by-gate, or element-by-element, as the control routine is processed in systematic, element-by-element fashion, rather than after all of the underlying logic has been evaluated or processed. While not every ladder logic element encountered will give rise to the separate generation of a corresponding Boolean logic element in the output, the disclosed conversion technique generates each element or portion of its output in response to, and as a result of, encountering a subsequent ladder logic element. Nonetheless, the order in which the Boolean logic elements or gates are generated is also indicative of the order in which they should be evaluated during execution of the Boolean logic output. Thus, this sequential approach to conversion results in an ordered set of Boolean logic elements that maintains the original execution order of the underlying ladder logic.

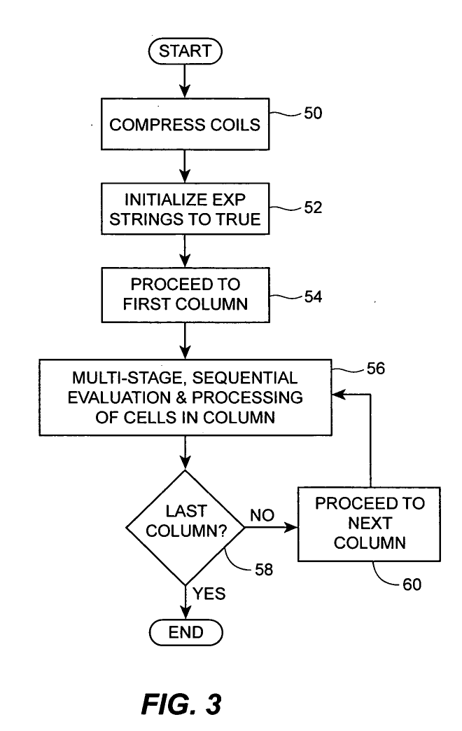

FIG. 3 presents an outline of the steps taken by the conversion routine in accordance with one embodiment of the disclosed conversion technique. These steps, and the more detailed steps described in connection with other figures, may be implemented as part of a software or other routine executed by one or more processors either separate and apart from, or integrated in, the process control system 10. Initially, control in the routine may pass to a preliminary coil compression block or step 50 in which each rung of the ladder is analyzed to determine generally, first, whether a coil is present, and second, whether the coil may be moved to simplify the rung. Despite the potential for simplification, practice of the disclosed conversion technique is not limited to circumstances in which coil compression is implemented. The need for coil compression may, in fact, depend upon whether a rule or convention establishing the execution order for the ladder logic mandates coil compression. That is, coil compression in accordance with the block 50 may be appropriate if the execution of the ladder logic requires coil compression. This situation may be present where, for instance, coils are only allowed in the far right-hand column, and where the execution order is vertical. In such cases, the execution order convention may establish that coils are to be evaluated in the first open position (or cell) in the rung. In other cases, the coil compression block 50 need not be implemented.

As briefly mentioned above, the disclosed conversion technique utilizes a number or set of logic expressions, one dedicated to each row or rung of the ladder, to maintain an account of the logic elements encountered thus far in connection with each ladder rung. Each logic expression therefore serves as a collection mechanism for the logic encountered, as will be described in greater detail below. After the coil compression is performed, control may pass to a block 52 to initialize each of these logic expressions. The block 52 may generate the logic expressions in connection with initializing them if, for instance, the expressions were not already created, or the correct number of expressions had not previously been created). In one embodiment, the block 52 includes generation of an array, EXP, having the appropriate number of elements, EXP₀, EXP₁, . . . EXPᵢ, where the subscript, i, denotes the row or ladder rung with which the logic expression is associated.

Whether each logic expression is stored as an array element or arranged in any one of a number of other ways, the block 52 generally enables the logic expressions to be stored as character or textual strings containing information or data resulting from the translation, e.g., the Boolean operators, operands, and gates or other functions. Such information is generally set forth using Boolean representations of the ladder logic elements. However, the logic expressions need not present the information strictly or solely in formal Boolean logic terms (e.g., C=A1 AND B2), insofar as the logic expressions are not the final output of the disclosed conversion technique, but rather an intermediate step. Thus, the Boolean representations may set forth the Boolean logic elements in a manner representative of, but not necessarily identical to, the manner in which the Boolean logic would formally be recited. However, in one embodiment, the information stored in the EXP₁ string takes the form of the text reciting the Boolean function established by the ladder logic elements within a particular rung. As an example, after analyzing a normally open contact in the first column of the first row, the string may look like EXP₀=A, where A is the contact variable. The collection of other ladder logic in that row (or other rows) will then result in the modification of that EXP string as will be explained herein below. Generally speaking, such collection and modification includes updating the respective logic expression to reflect a combination of the current logic expression with a representation of the next ladder logic element sequentially encountered in the row or ladder rung.

At this initial point, each EXP string is initialized in the block 52 to a value of “TRUE” to signify the potential for a connection to the rung 30. The value “TRUE” will then be combined with the ladder logic present in the cell of the first column to determine how the EXP₁ string should be modified.

After the EXP strings have been generated and/or initialized, control passes to a block 54 that causes the conversion routine to proceed to the first column to be evaluated, which, in the exemplary embodiment, is the cell 42 in the left-most column of the ladder. Multiple stages of evaluation and processing of the cells in the column are then conducted in a block 56. The multiple stages are directed to different types of ladder logic elements that may be present in each cell. This multiple-stage evaluation and processing of the cells generally proceeds sequentially from cell-to-cell within the column in accordance with the execution order, i.e., from the top-most rung of the ladder down. Although, in some embodiments, all of the cells within a column may be evaluated and processed in accordance with one stage, before the evaluation and processing for the second stage begins. Alternatively, all of the evaluation and processing of each cell may be conducted prior to proceeding to the next cell.

Generally, the evaluation performed in the block 56 determines an operation effected by the ladder logic element in the cell, such that the processing involves modifying the logic expression for the rung or row in which the cell is disposed to reflect the operation. For example, if a contact is disposed in the cell being evaluated, the modification performed in the block 56 updates the logic expression to reflect the result of the combination of the contact and the logic already collected in the logic expression.

When modifying or updating the logic expression, to update the logic expression, the block 56 may resolve a Boolean logic element from the information in the EXPᵢ string to avoid certain combinations. More particularly, a Boolean logic element is resolved from the logic expression when the combination would result in mixed or dissimilar logic functions (e.g., AND, OR, NOT) in a compound logic expression. For example, the following logic expression is compound, as it has more than one operator, and involves two different functions or operators: (A1 OR B2) AND B3. As explained further below, there may be other instances where a Boolean logic element is resolved. In any case, the new Boolean logic element is then stored in a memory, which, in one embodiment, involves storing the element in the next available position within a one-dimensional vector of data defining the Boolean logic elements. Additionally, a new identifier is created to represent the output of the Boolean logic expression.

Continuing with the foregoing example, if the logic expression prior to modification was EXPᵢ=A1 OR B2, then the information stored may be representative of the Boolean function, C=A1 OR B2. Once this new Boolean logic element has been resolved, the block 56 combines it with the logic introduced by the cell being evaluated. More particularly, the logic expression “A1 OR B2” is replaced by an identification or symbol for the new Boolean logic element, namely “C”. Because the latest cell might present a contact, B3, the modified EXPᵢ string becomes EXPᵢ=C AND B3. This modification process will be described in further detail below in connection with certain ladder logic elements, but generally speaking, it is an iterative procedure that (i) avoids building complex strings of Boolean logic having, for instance, one or more parenthetical expressions in compound or nested arrangements involving mixed or dissimilar functions or operators, while (ii) generating an ordered sequence of distinct Boolean logic elements in accordance with the execution order. To these ends, the distinct logic elements are stored as objects disassociated and apart from the logic expressions from which they were generated.

In the exemplary case of converting the ladder logic of FIG. 2, the first instance of execution of the block 56 would include encountering the contact 36A. Modification of the EXP string thus involves combining the current string (“TRUE”) with a normally open contact. The conversion routine processes that particular combination to update the EXP string, EXP₀, to recite the point name of the contact 36A. No Boolean logic element is resolved, in this case, because the logic expression still has only a single operand and remains, therefore, simple (or non-complex).

The remaining blocks shown in FIG. 3 are generally directed to navigating the conversion technique through the remainder of the ladder. Accordingly, the details depend upon the conventions being converted, but in this embodiment, a decision block 58 determines whether the conversion routine is presently at the last, or right-most, column in the ladder, in which case the routine ends. If the last column has not yet been encountered, then control passes to a decision block 60 that causes the conversion routine to proceed the cell in the next top row of the next column.

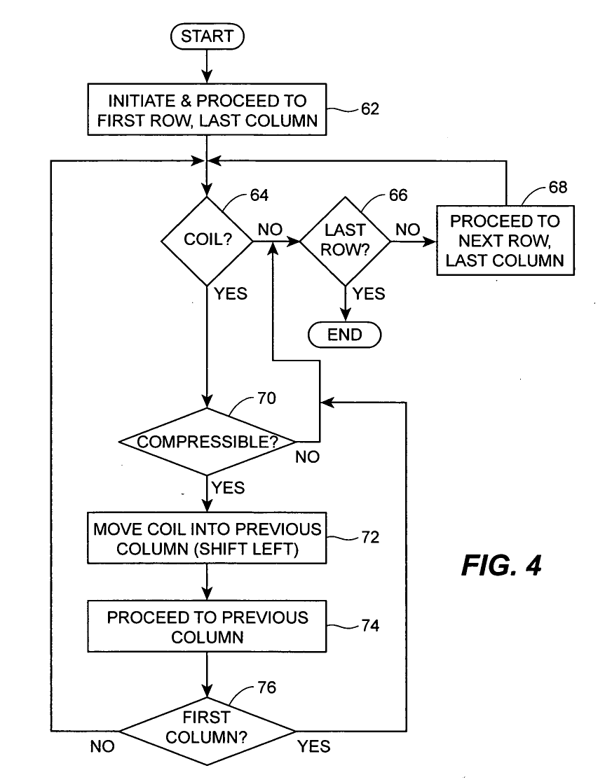

With reference now to FIG. 4, the coil compression routine of the block 50 is shown in greater detail. As explained above, coil compression may be implemented prior to executing the ladder logic (and therefore prior to any translation steps). Coil compression generally involves shifting coils in the ladder to the left, if possible. The routine begins in a block 62 that initially sets the current row and column to the first (e.g., top) row and last (e.g., right-most) column. A decision block 64 determines whether the cell associated with the current row and column has a coil. If no coil is present, then control passes to a decision block 66 that determines whether the last row or rung has just been evaluated, in which case the procedure would end. Because the first row was evaluated, however, control passes to a block 68 that increments the current row such that routine proceeds to the last column of the next row.

In the event that a coil is present in the current row, a block 70 determines whether the coil is compressible. Generally speaking, the block 70 evaluates adjacent cells in both the current row and an adjacent row to perform this evaluation. Ladder logic in an adjacent rung may be relevant if, for instance, an OR function is present that connects the adjacent rungs. In this exemplary embodiment, compressibility is determined by evaluating whether two conditions are met, namely (i) whether a pass-through or line is present without an OR function in the cell in the previous column (e.g., the next column to the left) of the current row, and (ii) whether the current row is the last row in the ladder, or whether the cell in the next row and previous column does not have an OR function. If both conditions are met, then the current coil is compressible.

If the coil is not compressible, control returns to the block 66. If the coil is compressible, control passes to a block 72 that moves or shifts the coil in the current cell into the previous column. A block 74 then decrements the current column such that the routine can proceed to evaluate whether the coil can be further compressed. If a block 76 determines that the current column is now the left-most column in the ladder, then no further compression is possible, and control returns to the block 66 to see if any further rows are present. If the current cell is not in the first column, then control returns to either the block 64 to determine whether further compression can occur within the current row. Because the coil has just been shifted into the current column, the block 64 will pass control to the block 70 for another compressibility evaluation.

After the coil compression routine has progressed through the entire ladder, then the ladder is ready for processing by the remainder of the conversion routine. More generally, the ladder may be modified in any manner in preparation for conversion. Modifications may be necessitated by the ladder logic rules or conventions for execution, such as an execution order, or for any other reason, as desired.

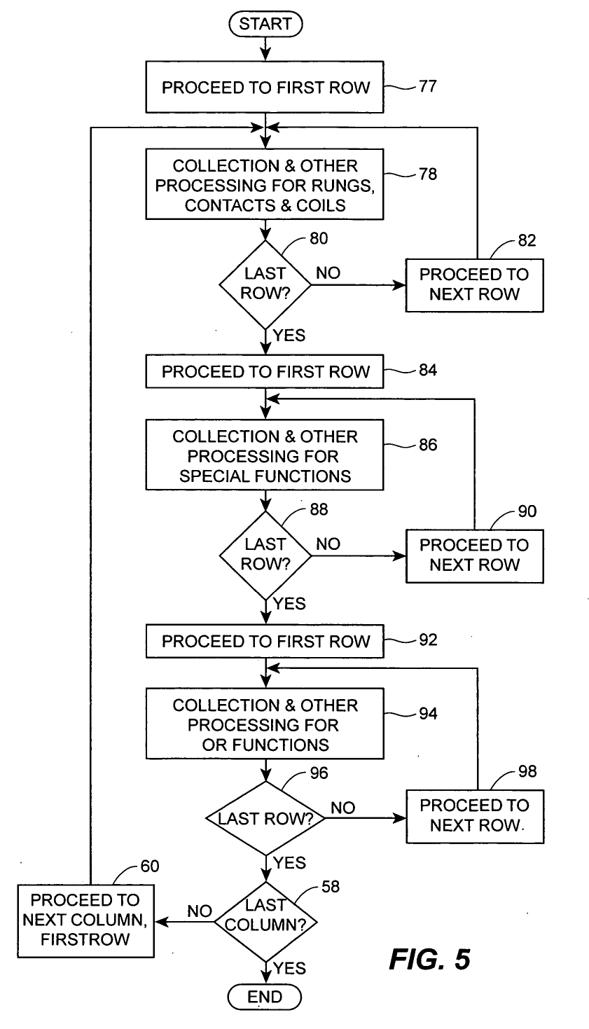

Referring now to FIG. 5, the logic conversion routine includes a number of processing stages respectively dedicated to evaluating, and then converting or processing, one or more types of ladder logic elements. Each stage may be implemented via a separate routine, routine portion or subroutine, and/or may involve calling procedures or executing routines common to each stage. Generally, each stage of processing is executed for every cell, unit or portion of the ladder being converted. In this way, the routine is capable of handling the situation where a cell is defined to have more than one logic element (e.g., a contact and an OR function). In the exemplary embodiment of FIG. 5, the logic conversion routine establishes a three-stage approach, i.e., such that each cell is evaluated and processed three times, once for rungs, contacts, and coils, then for special function blocks, and then for OR functions. In alternative embodiments, the approach may address the various ladder logic elements in different groups resulting in any number of different stages, including where all of the processing is integrated into a single-stage routine. Certain embodiments may also skip one or more stages when, for instance, the ladder logic element spans more than one cell.

Each stage of the evaluation and processing is implemented by one or more routines or subroutines that evaluates and processes the ladder logic elements encountered. The processing portion of each stage includes collecting Boolean representations of the ladder logic elements in the respective logic expressions for each ladder rung. In one embodiment, such collection, in turn, involves sequentially modifying each logic expression to represent the current state of the evaluation of each rung of the ladder. In this way, the logic conversion routine proceeds through the ladder in the execution order, sequentially updating the respective logic expression for the row of the cell being processed to reflect the logic element(s) encountered. As set forth above, the block 54 (FIG. 3) sets the current column such that evaluation and processing begins with the left-most column. A block 77 may then set the current row to the first row to proceed from the top to the bottom within each column.

The first processing stage involves a block 78 that evaluates the current cell for rungs (i.e., a pass-through or a line), contacts, and coils. Even though the logic presented by these elements warrants different conversion processing, each of these ladder logic elements are single-rung elements, insofar as they are disposed completely within a row or rung such that the cells in which they are disposed do not present a connection with any other row or rung. When a contact is encountered, the block 78 collects the contact by modifying the logic expression for the current rung to reflect the contact through a combination of the contact with the logic expression. Because, in this embodiment, the logic expression is a textual string expressing the logic in Boolean form, this combination may result in the addition of text to the string, or one or more replacements of text within the string, where a Boolean gate or element may be substituted for the logic function that they represent, as will be explained in detail below. Generally speaking, however, the value of the logic expression may be substituted or resolved when the EXPᵢ string contains a complex object, such as “A1 AND B2.” Such complex objects are in contrast to non-complex logic expressions having only one logic element term, as in when EXPᵢ=TRUE or EXPᵢ=A1. Resolving the string includes, in one embodiment, building a Boolean gate or element in accordance with the logic set forth in the expression. As an example, the gate could be represented by the identification symbol, C, and C could be set equal to the logic function, “A1 AND B2”. In such cases, the new identification symbol, i.e., the Boolean element C, created as a result of the evaluation is then inserted back into the expression, replacing the portion of the expression of which it is now representative and thereby enabling the collection and incorporation of the new contact into the logic expression.

Resolving a Boolean element from the logic expression may involve or include any act by the conversion routine that forms, determines, or generates a Boolean element from the information set forth in the logic expression. An identification symbol for the new Boolean element is then assigned and used to set forth a modified logic expression. In other words, a representation of the Boolean element, the new identification symbol, is re-inserted into the logic expression from which the Boolean element was resolved. The logic expression has thus been updated and simplified, and a complex element, such as “A1 AND B2,” has been replaced by the new identification symbol of the resolved Boolean element, a non-complex element (e.g., C) defined as equal to the previous complex element, i.e., A1 AND B2.

After the current cell has been processed by the block 78, a block 80 determines whether the last row in the column has been reached. If not, a block 82 increments the current row and returns control to the block 78 for collection and processing of the next cell within the current column. Once all of the cells within a column have been processed, the block 80 passes control to a block 84 that resets the current row to the first row in preparation for the next processing stage.

The second stage of processing is implemented in a block 86, and is directed to evaluating the current cell for special function blocks. The collection and processing routine of the block 86 also may result in the modification of the logic expression for the rung in which the current cell is disposed, which may, in turn, result in one or more Boolean logic elements or gates being resolved from the EXPᵢ string for the current cell. Such steps taken here in connection with special functions may, nevertheless, utilize procedures or routines used by other processing stages. For example, multiple processing stages may call the same procedure for resolving a Boolean logic element from the current EXPᵢ string. Further detail regarding the processing of special functions is presented below in connection with an exemplary ladder logic convention.

After the current cell has been evaluated and processed for special functions, a pair of blocks 88 and 90 implement the same loop as the blocks 80 and 82 in order to process each of the cells within the current column. In fact, the blocks 88 and 90 may involve the same routine or subroutine as the blocks 80 and 82, and are shown separately only for ease in illustration. In similar fashion to the block 84, a block 92 resets the current row to the first row in preparation for the next processing stage once processing of the current column is complete.

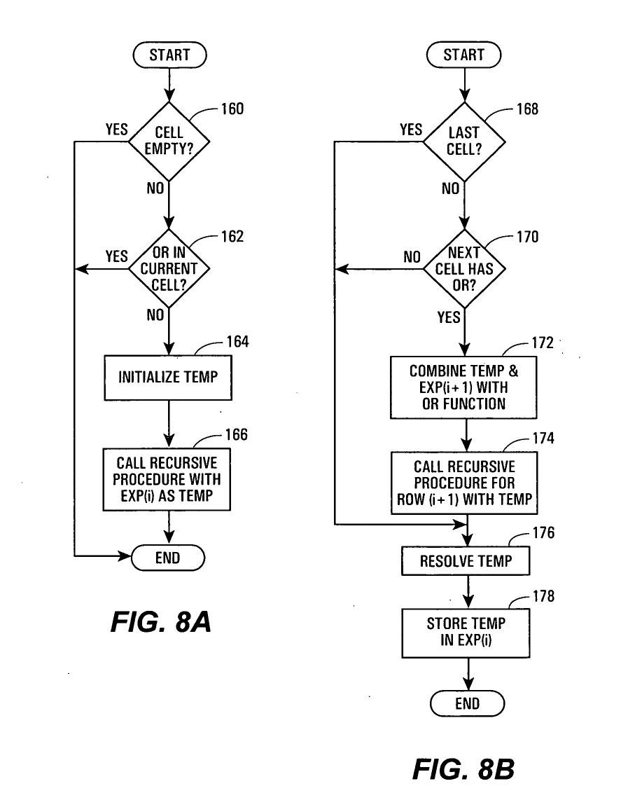

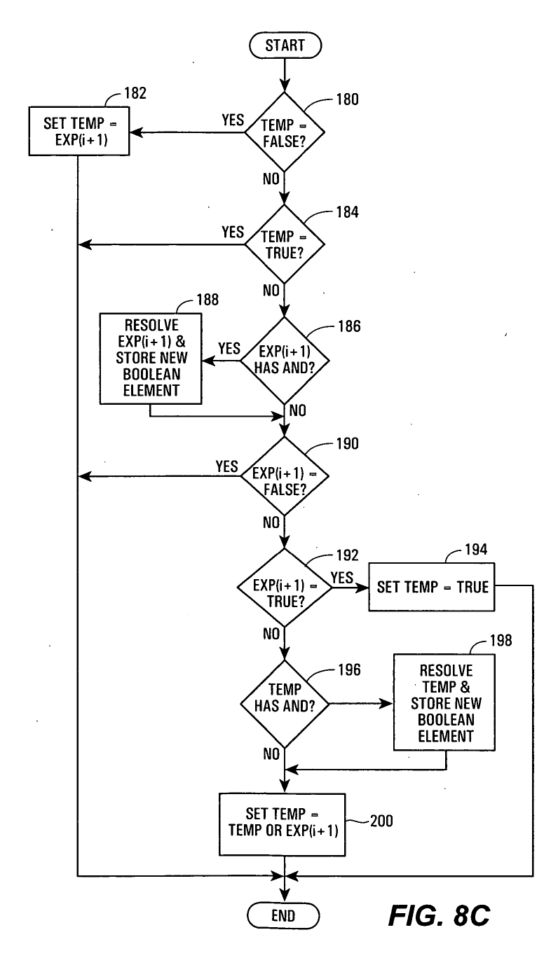

Next, a block 94 implements an evaluation and subsequently processes the logic for OR functions associated with the current cell. The manner in which OR functions are processed may depend upon the ladder logic rules or conventions governing OR functions. For example, the current cell might be implicated by an OR function without having the OR function formally said to be contained within the cell. Stated differently, in the exemplary ladder logic system described above in which cells have attributes, a cell may be implicated by an OR function without having its OR attribute set equal to TRUE. Again, this situation is merely a matter of convention. In this case, the OR function may be disposed in the lower of the two cells joined by the OR function. However, regardless of how the ladder logic handles OR functions, the processing of OR functions in accordance with the disclosed technique generally results in a modification of the logic expressions of each ladder rung, or row, associated with, or connected by, the OR function. Further details regarding the processing of OR functions are set forth below in connection with the exemplary embodiment of FIG. 8.

After the current cell has been processed for OR functions by the block 94, blocks 96 and 98 form a loop to support such processing of each cell within the current column and, to that end, may call the same procedure as the blocks 80 and 82. Once the last cell within the column is reached, however, control passes to the block 58 (see also FIG. 3) to check if the current column is the last column. If not, control passes to the block 60 to proceed to the collection and processing of the ladder logic elements in the next column.

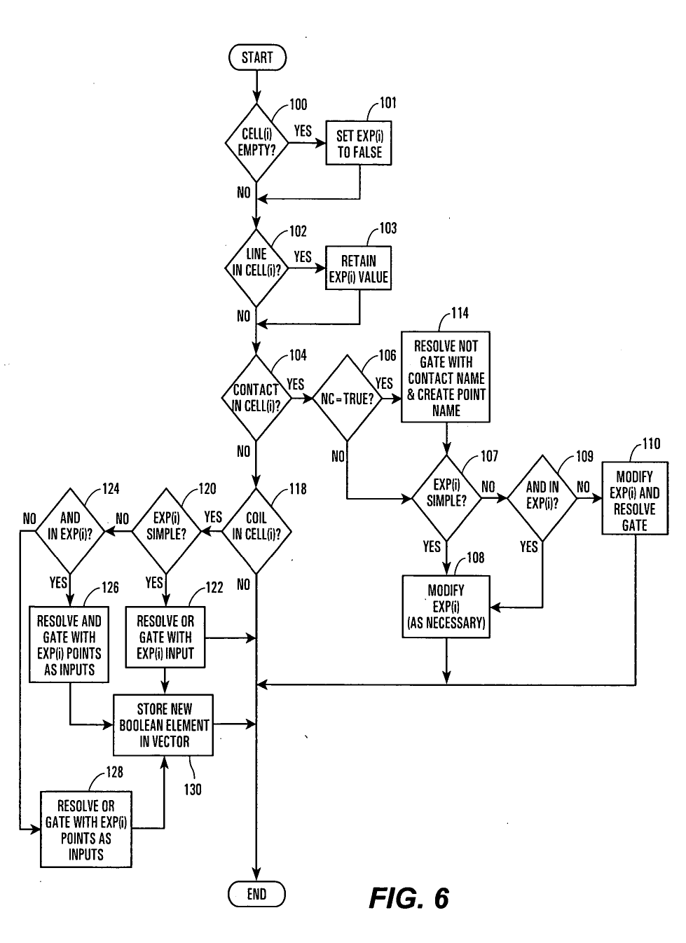

With reference now to FIG. 6, one embodiment of the evaluation and processing routine of the block 78 (FIG. 5) is shown in greater detail. As described above, this routine is directed to processing single-rung elements, such as coils, lines, and contacts, and may be executed for each cell or sequential unit of the ladder logic routine. The routine may begin in a block 100 by determining whether the current cell is empty, in which case the logic expression, or EXPᵢ, for the current rung is set to FALSE in a block 101. At this point, control may return to execute the remainder of the routine, or end because the cell is empty.

The single-rung element routine may continue in a block 102 that determines whether the current cell presents a pass-through or line, in which case control passes to a block 103 that maintains the current logic expression, or EXPᵢ value. At this point, the single-rung routine may end because the cell will not have any other elements. Alternatively, and as shown in FIG. 6, control passes to a block 104 that determines whether the current cell presents a contact, in which case a further block 106 determines the type of contact. The cell attribute NC (i.e., normally closed) will be true or false depending on whether the contact is normally closed or open, respectively. If the contact is normally open, control passes to a block 107 determines whether the EXPᵢ string presents a simple (i.e., non-complex) logic expression. If the EXPᵢ string is simple, then the collection of the contact is implemented by a block 108, which involves modifying or updating the logic expression to reflect the logic presented by the contact. The manner in which the logic expression is updated depends on the content of the logic expression prior to the combination, and the various possibilities are covered in Table I below.

If the EXPᵢ string is complex, then a block 109 determines what type of operator or function is present. If the string contains one or more AND operators, then control passes to the block 108, where the collection of the contact appends another AND function and an identification of the contact variable as a new operand. If the string contains one or more OR operators, then a block 110 resolves a new Boolean element representative of the logic expressed via the one or more OR operators, substituting the symbol or other identification of the new Boolean element into the string in combination with the contact. An example of this process will be shown below in connection with Table I. In this manner, the conversion routine avoids the commingling or mixing of different Boolean operators, i.e., the creation of a logic expression where more than one type of operator or function is present in a logic expression. More generally, however, collection and processing of contacts involves updating the EXPᵢ string by adding and/or replacing text to reflect the effect of the contact operation.

An example of the procedure executed in the blocks 107-119 for updating the logic expression is set forth below in Table I, in which logic variables and Boolean elements are identified by exemplary point names. To distinguish between the different point names involved, the point name X refers to the variable introduced by the newly encountered logic element, a contact. When a new Boolean element or gate is resolved as a result of the combination, then the new element is identified via a new, unique name, in this example, Y. Also, references to the logic expression “A1 AND B2” should be understood to refer to any string having one or more AND operators. Similarly, references to the logic expression “A2 OR B1” should be understood to refer to any string having one or more OR operators. The “Combination Type” column of Table I is established by the nature of the ladder logic encountered and, more specifically, indicates the context for the combination of the contact X, i.e., whether the contact X is being combined via an AND or an OR function. The manner in which combinations occur based on an OR function will be described further below. The “Resolve” column indicates whether a new Boolean element is resolved as a result of the combination, resulting in a substitution of the new, unique element, Y.

TABLE I

| Prior EXPᵢ String | Combination Type | Resolve | Resultant EXPᵢ String |
|---|---|---|---|
| FALSE | AND | No | FALSE |
| FALSE | OR | No | X |
| TRUE | AND | No | X |
| TRUE | OR | No | TRUE |
| A1 | AND | No | A1 AND X |
| A1 | OR | No | A1 OR X |
| A1 AND B2 | AND | No | A1 AND B2 AND X |
| A1 AND B2 | OR | Yes | Y OR X |
| A1 OR B2 | AND | Yes | Y AND X |
| A1 OR B2 | OR | No | A1 OR B2 OR X |

Table I shows that a new Boolean element or gate is not resolved in cases involving simple EXPᵢ strings, i.e., the first six entries in the table. Only when a complex EXPᵢ string is combined in a way that mixes AND and OR operators is a new Boolean element resolved. Otherwise, the complex EXPᵢ string may remain a string having multiple AND operators, or multiple OR operators.

With continued reference to FIG. 6, if the block 106 determines that the encountered contact is normally closed (e.g., the NC attribute for the current cell is set to TRUE), then control passes to a block 114 that resolves a new Boolean element, a NOT gate, prior to proceeding with the logic expression combination procedure described above in connection with the blocks 107-1 10. More particularly, the block 114 creates a unique point name for the NOT gate, defining it in terms of the resolved Boolean logic element. For example, the contact 36D of FIG. 2 may be associated with the point name D1, such that the element resolved by the block 114 is defined in terms of a unique point name, MIG-DX-0000, and the Boolean function, NOT (D1). Of course, the logic conversion routine may express or store this Boolean logic in a different manner, or in accordance with the process control configuration software implementing the logic. For instance, the logic may be generated and/or stored in the following manner: MAKE NOTIN, IN1=D1, OUT=MIG-DX-0000. The exemplary configuration software understands this instruction to recite that a NOT gate should be defined as having an input value set equal to the information in the memory associated with the variable, D1, and as having an output associated with the unique name, MIG-DX-0000.

The block 114 resolves a new Boolean element to avoid a combination of dissimilar or mixed Boolean functions in a logic expression, in this case, the combination of NOT and one of the functions, AND and OR.

Each time that a new Boolean element is resolved via execution of the blocks 110 or 114, information or data indicative or defining the new Boolean element is saved in a memory in the order in which they were created. In one embodiment, the information is recorded in the next step taken by the conversion routine. Alternatively, the information is recorded at a later time but in a manner that preserves the order in which the Boolean element was resolved (relative to other resolved Boolean elements). For instance, the recordation of the resolved Boolean element may occur at the point that the next Boolean element is to be created. In any event, storing the Boolean elements in the order in which they were resolved is a way of preserving the execution order of the ladder logic, which is based on the manner in which the disclosed logic conversion technique sequentially processes the ladder logic. To this end, the memory in which the Boolean elements are stored may be one-dimensional, or a vector, in the sense that the elements are stored in a one-dimensional sequence or order. It should be noted, however, that the information related to the Boolean element (e.g., MAKE NOTIN, IN1=D1, OUT=MIG-DX-0000) may be stored in multiple components (e.g., TYPE, IN, OUT, etc.) rather than as a single, integrated instruction. It should also be noted that the memory in which the Boolean elements are stored may, but need not, be any one or more of the memories within the process control system 10, such as one of the memories 27, and may or may not constitute the same memory in which any other routine or information associated with the conversion is stored.

Once each new Boolean element is stored in the vector or other memory, the single-rung element processing routine may end (as shown in FIG. 6), or continue as if a contact was not encountered. When the current cell does not contain a contact, control passes to a decision block 118 that determines whether a coil is present. The evaluation and processing associated with coil elements generally involves resolving the logic expression for the rung in which the current cell is disposed. The logic expression may be complex, and therefore include an OR string or an AND string, or may be simple (i.e., non-complex), and therefore present a single term Boolean element. In either case, the presence of a coil causes a Boolean element to be resolved as shown in FIG. 6. It should also be noted that the processing implemented in resolving and storing a Boolean element may, but need not, involve the same routine, routine portion, subroutine, or procedure, regardless of the ladder logic element encountered (i.e., contact, coil, etc.). More generally, the processing stages need not constitute distinct and separate routines, but rather may involve any number of shared procedures, routines, etc.

With continued reference to the processing of coil elements as shown in FIG. 6, if the EXP string is simple, then a decision block 120 passes control to a block 122 that resolves an OR gate with the Boolean element identified in the EXPᵢ string as the sole input. However, in an alternative embodiments, any function that can accept a logic parameter as an input and generate an output logic parameter having the same value as the input parameter may be used instead of the OR gate. Examples include a single-input AND gate, an ASSIGN function (which takes a single input and generates the value of the single input as an output under a different variable), and other buffer-type elements. If the EXPᵢ string is complex, then control passes to a decision block 124 that determines whether an AND operator is present in the EXPᵢ string. If the string is an AND function, then a new AND gate is resolved in a block 126. The variables or point names identified in the EXPᵢ string are taken as the inputs to the AND gate. Otherwise, a new OR gate is resolved in a block 128, in which the point names are again taken as the inputs to the gate. In each of these cases, after the Boolean element is resolved, control passes to a block 130 that stores the information associated with the element in the vector or other memory.

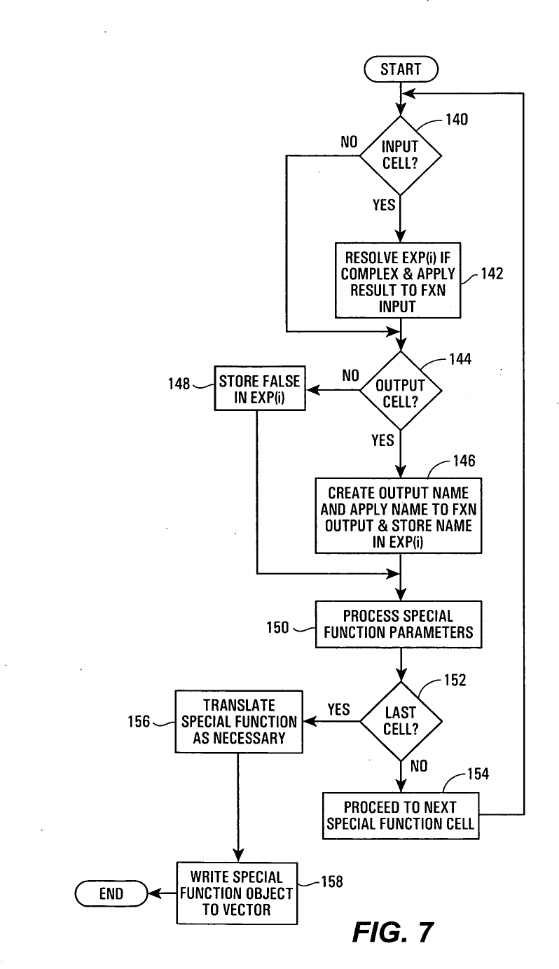

The evaluation and processing steps set forth in connection with the exemplary embodiment of FIG. 6 generate a collection of Boolean logic gates or elements that are stored in a memory as separate objects in a sequence in accordance with the execution order of the ladder logic. These objects are the results of translating standard ladder logic elements and functions, such as coils and contacts. The disclosed conversion technique, however, also supports the conversion of non-standard ladder logic elements, or special functions, that may be disposed in the ladder. The steps taken toward the evaluation and processing of special functions are shown in FIG. 7. In contrast to elements such as coils or contacts, special functions may (but need not) reside in more than one cell or unit of the ladder. Depending on the conventions or rules of the ladder logic, a special function may reside or include a number of cells across different rungs and/or different columns. As a result, when the disclosed conversion technique is applied to ladder logic having a sequential order defined by cells or units, then the translation of special functions may span more than one rung or column. In those cases, the routine may process all of the cells associated (or spanned by) a special function during the same pass or separately. The exemplary embodiment of FIG. 7 effectively does both, insofar as the special functions in this exemplary system reside in the same column. Upon encountering the first cell of the special function, the routine processes each cell of the special function separately, proceeding through the ladder on a cell-by-cell basis, until the last cell within the special function is reached. But this need not be the case, and practice of the disclosed conversion technique is not limited to the types or shapes of special functions shown or described herein.

In the example shown in FIG. 2, the special function 40 spans two cells. Each cell typically defines or has associated therewith one or more parameters. Parameters may establish an input or output variable for the special function, store a temporary value of a variable, or establish a constant value used during execution of the special function. As shown, the first cell of the special function has the input parameter, IN1, and the constant 100, while the second cell of the special function has the output parameter, OUT2.

The components of the special function are arranged in accordance with the cell attribute, SHAPE, where the beginning or start of the special function has a SHAPE=TOP, and then the last cell or end of the special function has a SHAPE=BOT. Therefore, the upper cell of the special function 40 has a TOP shape, while the lower cell has a BOT shape. Cells in between the start and end of the special function may have another SHAPE value, such as MID. In this way, the conversion routine “remembers” that it is still in the midst of processing a special function when it moves to the next vertically adjacent cell, despite having proceeded as if the cell was any other cell (by executing, for instance, the routine of FIG. 6).

The evaluation and processing of special functions will now be set forth in greater detail in connection with the exemplary embodiment of FIG. 7. The steps shown in FIG. 7 assume that a special function has been detected, whether via the detection of a cell having a SHAPE attribute equal to TOP, or via some other mechanism, as desired. If a special function is not detected, the logic conversion routine may skip the steps shown in FIG. 7 and proceed to the next evaluation and processing stage.

Cells associated with special functions may have a number of attributes only used in connection with special functions. The attributes INUB and ONUB are TRUE or FALSE depending on whether the cell has an input or an output, respectively. The NUMBER attribute may be used to identify the number of the cell in the special function (e.g., the first cell having NUMBER set equal to 1), which may be used in identifying special function parameters by cell number. In the example of FIG. 2, the input of cell number one of the special function 40 is associated with the parameter IN1, while the output of the cell number two is associated with the parameter OUT2. The ARG attribute identifies the parameter type for the cell, where CONST, HREG, POINT_NAME, and NONE are indicative of a constant integer, a holding register, a point name, and no parameter, respectively. The attribute HREG may identify the name of the holding register. Similarly, the attribute POINT_NAME may identify a point name, and the attribute CONST may contain the value 100.

Generally speaking, the values of the foregoing attributes will define one or more parameters of each cell of the special function. During the evaluation of a special function, the disclosed conversion technique processes the special function by sequentially processing the parameters of each cell in accordance with the nature of the special function. Evaluation and processing of the parameters provides the foundation for mapping, or translating, the special function from the ladder logic configuration scheme to the Boolean logic scheme.

FIG. 7 shows the steps taken by the special function processing stage of the routine. Once a special function has been encountered in the current column being evaluated, a decision block 140 determines whether the current cell has an input by analyzing the INUB parameter. If INUB is TRUE, then a block 142 resolves the logic expression in the event that the EXP string is complex. This resolving step may use the same or similar procedure as that described above in connection with coils and contacts. In either case, a Boolean element may be built based on the logic set forth in the EXPᵢ string, and stored in the vector or other memory along with the other Boolean elements. The block 142 then sets the input parameter equal to the resultant Boolean element.

Eventually, control passes to a decision block 144 that determines whether the current cell has an output by analyzing the ONUB parameter. If ONUB is TRUE, then a block 146 that creates a unique, point name for this output, applies the name to the output for the cell (defining the output as equal to the name), and stores this association in the EXPᵢ string, replacing any prior text in the string. If the cell does not have an output cell, a block 148 stores FALSE in the EXPᵢ string.

Control then passes to a block 150 that processes any other (i.e., non-input, non-output) special function parameters in each cell. Other parameters may define aspects of the special function. For instance, if the special function is a timer, then a parameter that may be defined in one of the cells of the special function is the constant that establishes how long the timer counts. The block 150 notes this time constant, and saves it to help define the special function in the Boolean logic scheme. The value may be saved in association with the cell number, as explained above.

Control then passes to a decision block 152 that determines whether the last cell in the special function has been reached by analyzing the SHAPE attribute. If the current cell does not have a SHAPE of BOT, then control returns to a block 154 that proceeds to the next vertically adjacent cell within the special function, and control returns to the block 140 for another iteration of processing of the special function. If the current cell has a SHAPE of BOT, then control passes to a block 156 that translates the special function into the corresponding function utilized in the Boolean logic scheme into which the routine is being converted. In some cases, this function may have the same name, parameters, and other characteristics as the ladder logic function. In other cases, the function may have different characteristics, but in either case, the block 156 may utilize a look-up table or other mapping information to identify the corresponding special function and transfer the special function parameters from the ladder logic scheme to the target scheme appropriately.

After the special function has been translated, a block 158 stores the special function and any parameter definitions in the vector or other memory that lists each of the logic elements generated by the disclosed conversion technique. Further processing of cells within the same column as the recently translated special function may then occur, with this stage of the routine generally evaluating the cells to determine whether to implement the steps shown in FIG. 7 again before proceeding to the next stage.

After scanning each cell in the current column for special functions, control passes to the final processing stage, which implements an OR function processing routine, an exemplary embodiment of which is shown in FIG. 8. The OR function processing routine generally combines the EXPᵢ string for each of the cells connected by the OR function, and then applies the resultant combination to the EXPᵢ string of each of the connected cells. Thus, an OR function associated with a cell generally combines the values of the EXPᵢ strings of two or more adjacent rungs. In one embodiment, an OR function present is present in the lower cell of the two connected cells, such that the OR function combines the EXPᵢ strings of the current rung and the one above it. Depending on the ladder logic conventions of the underlying control routine, alternative embodiments may establish that an OR function is present in the upper cell, such that the function combines the string of the current rung and the one below it.

Two or more OR functions may be used in combination, in which case the EXPᵢ strings of three or more rungs may be combined. Due to this possibility, the OR evaluation and processing routine may be a recursive procedure that processes one or more OR functions to make each of the necessary combinations. In the above-referenced embodiment where the OR function is present in the lower cell of the two connected cells, execution of the recursive procedure may be initiated when the current cell being evaluated does not have an OR function. Despite not having an OR function in the cell, the OR routine may be relevant because the cell below may have the OR function, thereby connecting the two adjacent rungs and implicating the current cell.

The OR function processing routine generally uses a temporary parameter to collect the logic expressions of each ladder rung connected by the OR function. This collection may involve combinations of logic elements, and such combinations are conducted in accordance with the disclosure in Table I hereof. For instance, when two logic expressions are combined as a result of an OR function, the combination type is “OR” and the fourth column of Table I may be consulted (e.g., consulted via a look-up table in a memory) to determine the manner in which they should be combined.

With reference now to the exemplary embodiment shown in FIG. 8A, the OR function processing routine may begin with a decision block 160 that determines whether the current cell is empty. An empty cell has no input, output, line, contact or other ladder logic element disposed therein, or an OR function in the cell below it (because, in certain ladder conventions, the OR function creates a vertical line connecting the two cells that creates an output for the current cell). If the cell is empty, then the OR processing routine may end, and the conversion routine moves onto the next cell in, for instance, the manner described in connection with the embodiment shown in FIGS. 3 and 5.

If the current cell is not empty, then a decision block 162 determines whether there is an OR function present in the cell. If an OR function is present, then the routine may also end, because the cells and rungs associated with that OR function will have already been processed by the recursive procedure to be described below.

If the current cell is not empty and does not contain an OR function, then a block 164 initializes a temporary string parameter, TEMP, in preparation for execution of the recursive procedure. More particularly, the initialization sets the TEMP parameter equal to the value set forth in the EXPᵢ string for the rung in which the current cell is disposed. The recursive procedure is then called in a block 166 with TEMP, i.e., the EXPᵢ string of the current rung, as an input parameter. This call of the recursive procedure returns the combined EXPᵢ string generated as a result of the combinations established by the OR function. As a result, the returned result becomes (i.e., is stored as) the EXPᵢ string for the current rung.

FIG. 8B depicts the recursive procedure. As a result of the procedure call with the TEMP string, control passes to a decision block 168 that determines whether the current cell is the last cell in a column. If so, the processing of the recursive procedure is essentially bypassed because no OR function can be present. Similarly, a decision block 170 determines whether there is an OR function in the cell below the current cell. If an OR function is not present, then, once again, the recursive procedure is essentially bypassed.

When an OR function is present in the cell below the current cell, then the two rungs are connected by an OR function, and the combination of the two strings, EXPᵢ and EXPᵢ₊₁, is performed in a block 172. More specifically, the combination involves the TEMP parameter and the EXPᵢ₊₁ string. Further details regarding this combination will be set forth below in connection with FIG. 8C.

Next, a block 174 establishes the recursive nature of the procedure shown in FIG. 8B, inasmuch as the procedure calls itself for the next row. In other words, additional combinations of logic expressions may be necessary because additional OR functions may be present, such that more than two rungs are connected. To see if further combinations are necessary, the procedure of FIG. 8B is called with TEMP as the input parameter. As a result, the combination present in TEMP resulting from the first execution of the recursive procedure becomes the string that may be combined in the block 172 with the EXPᵢ₊₂ string, if, in fact, the rung i+2 has an OR function as determined by the block 170.

This recursion continues until either the last row is reached (see block 168), or an OR function is not encountered in the cell below the current cell (see block 170). In either case, control may pass to a block 176 that resolves a Boolean element from the TEMP parameter.

Each layer of execution of the recursive procedure ends with the TEMP parameter being written back into the current EXPᵢ string for the procedure call (see the block 178). In this manner, each one of the strings eventually is assigned the value of the TEMP parameter.

The processing steps implemented by the block 172 to perform an OR combination will now be described in greater detail in connection with FIG. 8C. Initially, a decision block 180 determines whether the TEMP parameter is set to FALSE, in which case the combination effected by the OR function is simply set equal to the EXPᵢ₊₁ string. To that end, a block 182 sets the TEMP parameter equal to the EXPᵢ₊₁ string. Otherwise, control passes to a decision block 184 that determines whether the TEMP parameter is currently set to TRUE, in which case the combination effected by the OR function maintains the value of the TEMP parameter, and the routine ends.

Otherwise, control passes to a decision block 186 to determine whether the EXPᵢ₊₁ string needs to be resolved (i.e., whether a Boolean element needs to be resolved from the string). If the EXPᵢ₊₁ string has an AND operator, then control passes to a block 188 that resolves the string, stores the newly created Boolean element in the vector or other memory, and sets the TEMP parameter to the newly created output from the resolved logic. If the EXPᵢ₊₁ string does not have an AND operator, a decision block 190 determines whether the EXPᵢ₊₁ string is currently set to FALSE, in which case the TEMP parameter is unmodified by the string, and the routine ends. Alternatively, if a decision block 192 determines that the EXPᵢ₊₁ string is currently set to TRUE, then control passes to a block 194 that sets the TEMP parameter to TRUE as a result of the OR combination.

If the EXPᵢ₊₁ string is not set to TRUE, then control passes to a decision block 196 to determine whether the TEMP parameter has an AND operator and, therefore, needs to be resolved in preparation for an OR combination. If so, a block 198 resolves the TEMP parameter, thereby creating a new Boolean element, data representative of which is stored in the vector or memory, and sets the TEMP parameter to the newly created output from the resolved logic. After the TEMP parameter has been resolved, a block 200 performs the OR combination by setting TEMP equal to the logic expression having TEMP and EXPᵢ₊₁ separated by an OR operator.

To provide an example of the processing steps taken by the disclosed conversion routine, the processing of the exemplary ladder logic of FIG. 2 will now be described in connection with one embodiment of the disclosed conversion technique. The ladder logic is first processed to determine whether coils can be shifted. Accordingly, the block 64 finds the coil 38A, and the block 70 determines that the coil is compressible due, in part, because no OR function is present in the cell to the left and below of the current cell. The block 72 then shifts the coil one cell to the left, and the block 74 sets the current column to the one second from the rail 32. The coil 38A is again found by the block 64, but this time the block 70 finds the OR function connecting the rungs 34A and 34B (see the cell containing the contact 36D). The coil compression routine continues as shown in FIG. 4, and only results in one other shift, an action taken in connection with the coil 38D.

After the coil compression processing, the conversion routine begins to process the ladder cell-by-cell in sequential fashion according to the execution order, and therefore starts with the cell and column having the contact 36A. To continue with the example, the following point names are associated with the contacts and coils shown in FIG. 3:

TABLE II

| Contact | Point Name |
|---|---|
| Contact 36A | A1 |
| Contact 36B | B1 |
| Contact 36C | C |
| Coil 38A | C |
| Contact 36D | D |
| Coil 38D | E |

The EXP strings will be identified by row number, starting with row 0, and are initialized to the value, TRUE. The conversion routine begins the three stages of collection and processing with the routine shown in FIG. 6, and the block 104 finds the normally open contact 36A. With NC set equal to FALSE, the block 108 combines EXP₀ with the point name A1 in accordance with the combination rules of Table 1, such that EXP₀ is set equal to A1. Continuing with the rest of the first column, the conversion routine then proceeds to the cell below, where the contact 36B is encountered. The routine processes the cell in a similar fashion to the steps taken in connection with the first cell, such that EXP₁ is set equal to B1. Moving to the third rung, the block 102 finds a line in the cell, such that EXP₂ retains a value of TRUE. And lastly, the last two rungs are empty, such that the strings, EXP₃ and EXP₄, are modified to a value of FALSE via operation of the block 101.

As shown in FIG. 5, processing of the first column then turns to the second stage for special functions in accordance with the block 86. The special function stage of FIG. 7 then fails to encounter a special function, and processing turns to the third stage for OR functions. With no OR functions present in the first column, the OR processing routine finishes for each cell after one call to the recursive procedure, where the block 170 does not find an OR function below the current cell.

The routine proceeds to the second column as a result of reaching the blocks 58 and 60 of FIG. 3, and the first stage of processing begins again with the top cell in that column. Lines are encountered in the first two cells, maintaining the first two logic expression values (i.e., EXP₀=A1 and EXPᵢ=B1). With the third rung, the contact 36C is encountered such that the EXP₂ string is set equal to C via operation of the blocks 107 and 108. No further modifications are made to the logic expressions during the first stage of processing this column. Implementation of the second and third processing stages for this column also do not result in any modifications.

The conversion routine continues with the third column, where the first stage of processing retains the value of the logic expression of the first rung before encountering the normally closed contact 36D in the second row. Until this point, modifications of the logic expressions have occurred, but no Boolean logic elements have been resolved from the logic expressions. The first Boolean logic element resolved and recorded, a NOT gate, is necessitated by the normally closed aspect of the contact 36D. Specifically, the block 114 resolves or generates a NOT gate, storing its definition in the first position of the vector or memory as the first object in the Boolean logic output. The NOT gate may be defined via storage of information, such as the string “MAKE NOTIN, IN1=D, OUT=MIG-DX-0001”. After the NOT gate is resolved, the operation of the blocks 107 and 108 cause the EXP₂ string to be modified to reflect the collection of the contact 36D. Specifically, the EXP₂ string becomes the string “B1 AND MIG-DX-0001”. With no other contacts or coils in the third column, the routine proceeds to the second processing stage.

In the second stage, the routine next encounters the special function 40, where the block 140 (FIG. 7) determines that the first cell has the TOP and INUB attributes set to TRUE, such that the block 142 applies the value of the EXP₂ string, C, to the IN1 function parameter. The special function processing routine of the block 150 also encounters the constant, 100, in the first cell, thereby establishing that the parameter, CELL1, is set equal to 100. This constant represents the time period that the timer will remain on after actuation. The routine eventually proceeds to the next special function cell via the block 154. As an output cell, the block 146 creates an output name, e.g., MIG-DX-0002, and applies the name to the EXP₃ string such that the string is now set equal to MIG-DX-0002. This name is also applied to the special function parameter, OUT2. The block 150 then processes any special function parameters. Insofar as there are no other parameters for the special function, the block 152 then determines that the last cell in the special function has been processed. The block 156 then takes the input, output and other parameter information gathered for the special function for translation into the corresponding special function in the scheme utilized with the Boolean logic. Once the translation is complete, the block 158 writes the definition of the special function in that scheme to the next available position in the vector or other memory. For example, an exemplary timer having an “on” duration of 100 counts could be defined in the vector as follows: MAKE TIMER_ON, CELL1=100, IN1=C, OUT2=MIG-DX-0002. In this exemplary case, the preceding information is recorded after the definition of the first Boolean element, the NOT gate arising from the contact 36D.

The routine then proceeds to the third processing stage, where the first OR function of the exemplary ladder is encountered. The first cell of the third column has a line, but with a connection to an OR function in the cell below, which is uncovered by the block 170 (FIG. 8B) of the recursive procedure. The values of the TEMP parameter, which was set equal to the value of EXP₀ in the block 166, and the EXP₁ string are then combined in accordance with the processing steps shown in FIG. 8C and, specifically, the step taken in the block 200. As a result, both of the strings, EXP₀ and EXP₁, end up having the same value. More particularly, the recursive procedure is called such that the TEMP parameter is set equal to A1, the value of the EXP₀ string. The block 172 (FIG. 8B) then combines the TEMP parameter with the value of the EXP₁ string. That combination proceeds in accordance with the steps described in connection with FIG. 8C. Because the EXP1 string has an AND operator (i.e., “B1 AND MIG-DX-0001”), a new Boolean element is resolved via operation of the block 188. So the third Boolean element is now recorded in the next available vector position, for instance, as follows: MAKE AND8, IN1=B1, IN2=MIG-DX-0001, OUT=MIG-DX-0003. With this new, unique Boolean element, the block 200 performs the combination effected by the OR operator, such that the TEMP parameter is then set equal to the string “A1 OR MIG-DX-0003”. The block 174 causes another call of the recursive procedure for the second row with the value of TEMP. In this second iteration of the recursive procedure, the block 170 does not find an OR function in the next cell (i.e., the cell in the third row of the current column). As a result, the block 176 then resolves the next Boolean element from this TEMP parameter, such that the next available vector position then contains the following: MAKE OR8, IN1=A1, IN2=MIG-DX-0003, OUT1=MIG-DX-0004. The TEMP parameter is then set equal to MIG-DX-0004. The block 178 stores the value of TEMP in the EXP₁ string to end this iteration of the recursive procedure, after which control returns to the point of the first iteration at which the second iteration of the procedure was called. Specifically, control passes to the block 176, which causes the TEMP parameter to be resolved (again). But no additional Boolean logic is produced, because the TEMP parameter is simple (i.e., non-complex). The last operation taken during the third processing stage is provided via the block 178, which involves modifying the EXP₀ string to reflect the TEMP parameter. As a result, the value of the EXP₀ string is set equal to MIG-DX-0004.

The fourth column contains the coils 38A and 38D as a result of coil compression. As a result, the conversion routine next encounters the coil 38A, and the block 128 resolves an OR function from the EXP₀ string, such that the following is stored as the next resultant Boolean element: MAKE OR8, IN1=MIG-DX-0004, OUT=C. Subsequently, the coil 38D is processed such that the MAKE OR8, IN1=MIG-DX-0002, OUT=E, and the routine has resolved its final Boolean element.

The results of the routine conversion are shown below, where the order of execution begins with the first (or top) MAKE command, and continues through the remainder of the commands to generate each of the portions of the resultant Boolean logic routine.
MAKE NOTIN, IN1=D, OUT=MIG-DX-0001
MAKE TIMER_ON, CELL1=100, IN1=C, OUT2=MIG-DX-0002
MAKE AND8, IN1=B1, IN2=MIG-DX-0001, OUT=MIG-DX-0003
MAKE OR8, IN1=A1, IN2=MIG-DX-0002, OUT=MIG-DX-0004
MAKE OR8, IN1=MIG-DX-0004, OUT=C
MAKE OR8, IN1=MIG-DX-0002, OUT=E

Embodiments of the disclosed system and method may be implemented in hardware or software, or a combination of both. Some embodiments may be implemented as computer programs executing on programmable systems comprising at least one processor, a data storage system (including volatile and non-volatile memory and/or storage elements), at least one input device, and at least one output device. Program code may be applied to input data to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), or a microprocessor.

The programs may be implemented in a high level procedural or object oriented programming language to communicate with a processing system. The programs may also be implemented in assembly or machine language, if desired. In fact, practice of the disclosed system and method is not limited to any particular programming language. In any case, the language may be a compiled or interpreted language.

The programs may be stored as one or more sets of instructions, whether or not compiled, on a storage media or device (e.g., floppy disk drive, read only memory (ROM), CD-ROM device, flash memory device, digital versatile disk (DVD), or other storage device) readable by a general or special purpose programmable processing system, for configuring and operating the processing system when the storage media or device is read by the processing system to perform the procedures described herein. Embodiments of the disclosed system and method may also be considered to be implemented as a machine-readable storage medium, configured for use with a processing system, where the storage medium so configured causes the processing system to operate in a specific and predefined manner to perform the functions described herein.

When implemented in software, the routines described herein may be stored in any computer readable memory such as on a magnetic disk, a laser disk, an optical disk, or other storage medium, in a RAM or ROM of a computer or processor, etc. Likewise, this software may be delivered to a user-or to a process control system via any known or desired delivery method including, for example, on a computer-readable disk or other transportable computer storage mechanism or modulated over a communication channel such as a telephone line, the internet, etc. (which is viewed as being the same as or interchangeable with providing such software via a transportable storage medium).

The foregoing description is given for clearness of understanding only, and no unnecessary limitations should be understood therefrom, as modifications within the scope of the invention may be apparent to those having ordinary skill in the art.

What is claimed is:

1. A method of processing a routine expressed via ladder logic elements arranged in a plurality of ladder rungs and in accordance with an execution order, the method comprising the steps of:
collecting Boolean representations of the ladder logic elements in a respective logic expression for each ladder rung of the plurality of ladder rungs;
resolving Boolean logic elements from the logic expressions; and,
storing information regarding the Boolean logic elements in a memory in accordance with the execution order to express the routine in Boolean logic.

2. The method of claim 1, wherein the resolving step is performed if further collection of the Boolean representations in one of the respective logic expressions would result in a combination of dissimilar Boolean logic functions.

3. The method of claim 1, wherein the collecting step comprises the steps of evaluating each ladder logic element to determine an operation effected thereby and updating the respective logic expression to reflect the operation.

4. The method of claim 1, wherein the storing step comprises the step of writing to the memory a definition of the Boolean logic element as an object disassociated from the logic expression.

5. The method of claim 4, wherein the object is written to a position in the memory relative to further objects associated with further Boolean logic elements that preserves the execution order of the routine.

6. The method of claim 5, wherein the ladder logic elements are arranged in columnar positions within each ladder rung and wherein the execution order proceeds in columnar fashion.

7. The method of claim 1, further comprising the step of proceeding to a different ladder rung of the plurality of ladder rungs for a subsequent ladder logic element evaluation prior to evaluating another ladder logic element in the first-named ladder rung.

8. The method of claim 1, further comprising the step of compressing each ladder rung of the plurality of ladder rungs having a coil logic element prior to the generating step by shifting a position of the coil logic element within the respective ladder rung until another ladder logic element is encountered.

9. The method of claim 1, further comprising the steps of (i) identifying a non-Boolean function having units spread over multiple ladder rungs of the plurality of ladder rungs, and (ii) resolving a further Boolean logic element from a respective logic expression for the ladder rung of the plurality of ladder rungs connected to an input of the non-Boolean function.

10. The method of claim 9, further comprising the step of storing an object representative of the non-Boolean function in the memory in accordance with the execution order.

11. The method of claim 1, wherein the collecting step comprises the step of combining two or more respective logic expressions for adjacent ladder rungs of the plurality of ladder rungs linked via one or more OR functions to create a composite logic expression for each of the two or more respective logic expressions.

12. The method of claim 11, wherein the combining step comprises the step of executing a recursive procedure.

13. The method of claim 1, wherein the collecting step comprises the step of initializing the respective logic expression of each ladder rung of the plurality of ladder rungs to a value of TRUE.

14. The method of claim 1, wherein the resolving step is performed upon each instance of a coil in the plurality of ladder rungs.

15. The method of claim 1, wherein the resolving step comprises the step of resolving an inverter upon each instance of a normally closed contact in the plurality of ladder rungs.

16. A system for converting a logic routine expressed via ladder logic elements arranged in a plurality of ladder rungs, the system comprising:
a processor;
a computer-readable memory coupled to the processor; and,
a logic conversion routine stored in the computer-readable memory and configured to be executable by the processor, the logic conversion routine comprising:
a ladder logic element processing routine that collects Boolean representations of the ladder logic elements in a respective logic expression for each ladder rung of the plurality of ladder rungs, and that resolves a Boolean logic element from the respective logic expression when further collection would set forth dissimilar Boolean functions in the respective logic expression.

17. The system of claim 16, wherein the logic conversion routine further comprises an OR function processing routine that, when an OR function is encountered, (i) combines multiple, respective logic expressions for adjacent ladder rungs of the plurality of ladder rungs connected by the OR function to reflect a combination of the multiple, respective logic expressions and, (ii) modifies each of the multiple, respective logic expressions to reflect the combination.

18. The system of claim 17, wherein the OR function processing routine executes a recursive procedure.

19. The system of claim 18, wherein the recursive procedure is executed when the ladder logic element being processed does not contain an OR function.

20. The system of claim 16, wherein the ladder logic element processing routine comprises a coil processing routine that, when a coil is encountered in a current ladder rung of the plurality of ladder rungs, resolves the logic expression for the current ladder rung into a further Boolean logic element.

21. The system of claim 16, wherein the logic conversion routine further comprises a non-Boolean function processing routine that determines position information within a non-Boolean function having units spread over multiple ladder rungs.

22. The system of claim 21, wherein the non-Boolean function processing routine resolves a further Boolean logic element from the respective logic expression of each ladder rung of the plurality of ladder rungs determined to be coupled to an input of the non-Boolean function.

23. The system of claim 16, wherein the ladder logic element processing routine stores information defining the Boolean logic element as an object in a vector that maintains an execution order of the logic routine.

24. The system of claim 23, wherein the information defining the first-named Boolean logic element is stored before the ladder logic element processing routine proceeds to process a next ladder logic element.

25. The system of claim 16, wherein the execution order proceeds in columnar fashion such that consecutively processed ladder logic elements are arranged in different ladder rungs of the plurality of ladder rungs.

26. The system of claim 16, wherein the logic conversion routine further comprises a compression routine that compresses each ladder rung of the plurality of ladder rungs by shifting a position of a coil logic element within a ladder rung of the plurality of ladder rungs until another ladder logic element is encountered.

27. A computer program product stored on a computer-readable medium for conversion of a ladder logic routine expressed via ladder logic elements arranged in a plurality of ladder rungs, the computer program product comprising:
a first instruction set that collects Boolean representations of the ladder logic elements in a respective logic expression for each ladder rung of the plurality of ladder rungs; and,
a second instruction set that determines whether to resolve Boolean logic elements from the logic expressions;
a third instruction set that stores the Boolean logic elements in a memory in accordance with an order in which the Boolean logic elements are resolved.

28. The computer program product of claim 27, wherein the second instruction set is executed when further collection of the Boolean representations in one of the logic expressions by the first instruction set would result in a combination of dissimilar Boolean logic functions.

29. The computer program product of claim 27, wherein the first instruction set evaluates each ladder logic element to determine an operation effected thereby and updates the respective logic expression to reflect the operation.

30. The computer program product of claim 27, wherein the third instruction set writes to the memory respective definitions of each Boolean logic element as a respective object disassociated from the logic expression from which the Boolean logic element was resolved.

31. The computer program product of claim 30, wherein the order in which the objects are stored preserves an execution order of the ladder logic routine.

32. The computer program product of claim 31, wherein the ladder logic elements are arranged in columnar positions within each ladder rung and wherein the execution order proceeds in columnar fashion.

33. The computer program product of claim 27, further comprising a fourth instruction set that identifies a non-Boolean function having units spread over multiple ladder rungs of the plurality of ladder rungs, and that resolves a further Boolean logic element from a respective logic expression for the ladder rung of the plurality of ladder rungs connected to an input of the non-Boolean function.

34. The computer program product of claim 33, further comprising a fifth instruction set that stores an object representative of the non-Boolean function in the memory.

35. The computer program product of claim 27, wherein the first instruction set combines two or more respective logic expressions for adjacent ladder rungs of the plurality of ladder rungs linked via one or more OR functions to create a composite logic expression for each of the two or more respective logic expressions.

36. The computer program product of claim 35, wherein the first instruction set comprises a recursive procedure.
